(19) United States
(12) Patent Application Publication
(10) Pub. No.: US 2003/0012887 A1
(43) Pub. Date: Jan. 16, 2003

(54) Roller paint tray

(76) Inventor: Frank Orlikowski, Cheektowaga, NY (US)

Correspondence Address: MYRON AMER, P.C., Suite 310, 114 Old Country Road, Mineola, NY, 11501, US

(21) Appl. No.: 09/902,403

(22) Filed: Jul. 11, 2001

(51) Int. Cl. B05D 1/28

(52) U.S. Cl. 427/428

(57) ABSTRACT

A method of preparing a paint roller for painting service using a tray having an inclined apron and a screen of mesh construction material strategically positioned over the apron, and along which screen-covered apron the paint roller is alternatively urged in movement and during which paint initially adhered to a localized area of the roller is deposited in the interstices of the mesh and, as a consequence, is evenly spread over the entire external area of the roller which contributes to the paint being correspondingly evenly applied to wall and ceiling surfaces.

The present invention relates generally to improvements in the construction and operating mode of a paint-applying roller and paint-supplying tray, in which the improvements facilitate an even application of paint to wall, ceiling and like surfaces.

### EXAMPLE OF THE PRIOR ART

To avoid tedium and painting time, the use of a paint-applying roller, as compared to a brush, is the painting implement of choice in painting large areas, such as walls and ceilings. This preference is exemplified by U.S. Pat. No. 2,659,096 for “Strainer And Cleaner For Paint Rollers” issued to E. A. Mencfeldowski, Jr. on Nov. 17, 1952. In this, and all other known large area painting chores, the paint-applying roller is prepared by being dipped in a paint supply in a well of a tray, and an effort then made to spread the paint from the area on the roller in which the paint is absorbed by the dipping, evenly over the entire circumferential surface of the roller, preparatory to painting contact of the thusly prepared roller to the area to be painted. In the prior art preparation of the paint roller surface, there is an unavoidable squeegee response as well as a spreading by absorption in the paint roller surface being prepared, and such response results in an uneven distribution of paint about the roller surface and a correspondingly uneven distribution of paint on the surface being painted.

Broadly, it is an object of the present invention to overcome the foregoing and other shortcomings of the prior art.

More particularly, it is an object in the preparation of a paint roller paint-applying or transferring surface to obviate any squeegee phenomenon and to distribute the paint throughout the surface by absorption, from a dipped area to sequentially encountered undipped areas made accessible for absorption by rotation of the paint roller, all as will be better understood as the description proceeds.

The description of the invention which follows, together with the accompanying drawings should not be construed as limiting the invention to the example shown and described, because those skilled in the art to which this invention appertains will be able to devise other forms thereof within the ambit of the appended claims.

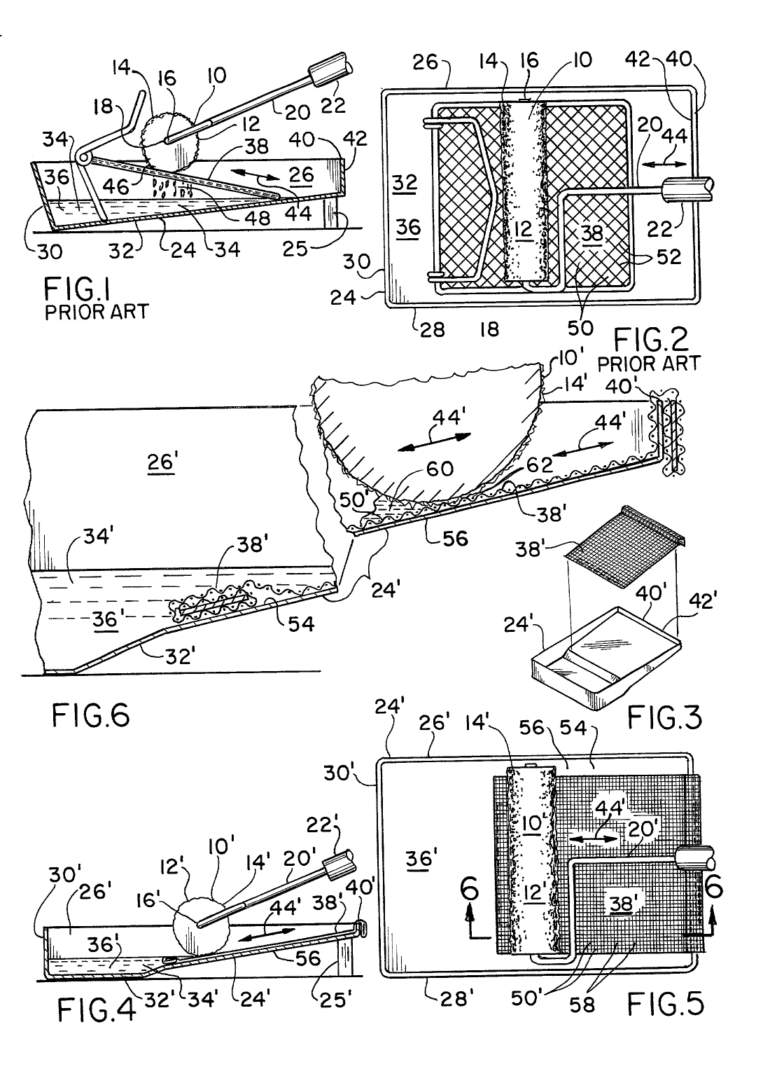

FIG. 1 is a side elevational view, in section, of a prior art roller paint tray;

FIG. 2 is a plan view projected from FIG. 1;

FIG. 3 is a perspective view, in reduced scale, of the unassembled components of a roller paint tray of the present invention;

FIG. 4 is a side elevational view, in section of the assembled components, and including a paint roller, of the roller paint tray of FIG. 3, similar in drawing perspective to the prior art drawing of FIG. 1 for comparison;

FIG. 5 is a plan view of the roller paint tray of the present invention, similar in drawing perspective to the prior art drawing of FIG. 2 for comparison; and

FIG. 6 is a partial sectional view, as taken along line 6-6 of FIG. 5.

As background and for contrast, reference should be made to a prior art roller paint tray illustrated in FIGS. 1 and 2 in which use is made of a paint roller, generally designated 10, consisting of a cylindrical body 12 of absorbent construction material presenting an external paint-applying surface 14, said roller being journalled for rotation, as at 16, on a horizontally oriented axle 18 with a rearwardly extending rod 20 having a hand grip 22 facilitating the urging of the paint roller 10 in movement relative to wall and ceiling surfaces resulting in paint previously applied to the external surface 14 being transferred to the wall and ceiling surfaces, the area of the wall and ceiling surfaces being of such a large extent that use of the paint roller 10 is deemed preferable to a brush as the painting implement of choice to lessen tedium and the time consumed in the painting chore.

Preparatory to actual use as just described of the paint roller 10, the paint must, of course, be applied to its external surface 14 and also must be evenly distributed over this surface in order to insure a proper transfer of the paint to the surfaces being painted. For proper preparation of the paint roller surface 14 use is made of a tray, generally designated 24, supported at an angle on legs 25 and made of bendable aluminum construction material, embodied with opposite side walls 26 and 28, a front wall 30, and a bottom wall 32 bounding therebetween a rectangular configuration serving as a paint repository, a supply 34 of which is placed in a front well or recess 36 into which the paint roller 10 is dipped.

Next, a user will typically prepare the roller for painting service by spreading the absorbed paint in the circumferential area dipped into the well 36 hopefully evenly, over the entire circumferential area of the surface 14. In the prior art tray 24 of FIGS. 1, 2, the preparation as described and illustrated in U.S. Pat. No. 2,659,096 for Strainer And Cleaner For Paint Rollers issued to E. A. Mencfeldowski, Jr. on Nov. 17, 1953, which by this reference is incorporated herein pursuant to MPEP 2163.07(b), consists of alternately urging the hand-gripped paint roller 10 in movement along a screen 38 supported in an angular orientation as illustrated in extended relation from an upper edge 40 of a tray rear wall 42 to a position immediately rearwardly adjacent the well 36, during which alternate movements 44 an excess of absorbed paint 46 is removed by contact with the wire construction material and partakes of gravity flow, as noted at 48, through the openings or interstices, individually and collectively designated 50, in the crisscrossed arrangement of the wire strands 52 assumed during the fabrication of the screen 38.

In a sharply contrasting operating mode, reference should be made to the roller paint tray according to the present invention in which structural features similar to those described in the FIGS. 1, 2 tray 24 are designated by the same but primed reference numbers, and other embodied structural features which constitute a patentable advance are numbered without a prime but in a continuing numerical sequence. More particularly, underlying the present invention is the recognition that to achieve a full and even coating of a paint layer over the paint roller surface 14′ incident to painting service thereof is better achieved by obviating slippage between the roller surface 14′ and the screen 38′ during the alternate preparation movements 44′. The screen 38′ in the roller paint tray embodiment 24′ of FIGS. 3-6 is supported from below and in actual surface-to-surface contract, at the interface of the roller surface 14′ with an upper surface 54 of an angled apron 56 extending from the top edge 40′ of the tray rear wall 42′ to the rear edge of the well 36′. As a consequence, excess paint is progressively deposited in the openings 50′ bottomed by opening-sized areas 58 delimited by the interstices 50′ of the screen 38′. In practice, it has been found that the paint deposits, individually and collectively designated 60, obviate slippage of the roller surface 14′ during its movements 44′ relative to the screen 38′ and it is believed that this observed operating mode phenomenon is due to the viscous nature of the paint which provides temporary adhesive attachment and release at the surface interface 62 between the roller surface and paint deposits 14′, 60 and that this, in turn, causes rotation of the roller 10′ during its preparation incident to wall and ceiling painting service.

While the apparatus for practicing the within inventive method, as well as said method herein shown and disclosed in detail is fully capable of attaining the objects and providing the advantages hereinbefore stated, it is to be understood that it is merely illustrative of the presently preferred embodiment of the invention and that no limitations are intended to the detail of construction or design herein shown other than as defined in the appended claims.

What is claimed is:

1. In painting a surface using a paint-applying roller, a method of evenly coating said roller with paint preparatory to painting use thereof comprising the steps of:
A. using a tray in a rectangular configuration having an inclined surface delimiting an apron and walls bounding a paint supply storage well;
B. filling said well with a supply of paint;
C. dipping a roller having an absorbent external surface into said supply of paint;
D. arranging to urge said roller in alternating movement along said apron incident to spreading said absorbed paint entirely over said roller external surface;
E. placing a screen with porosity and of metal construction material having edges bounding said porosity thereof delimiting openings therethrough in covering relation over said apron so as to have an operative position in an interposed position between said apron and said roller; and
F. preparing said roller for painting use by urging said roller in said alternating movement relative to said apron with said screen in said operative interposed position between said roller and apron;
whereby during said alternating movement said roller external surface is projected into said porosity openings to cause rotation thereof and to transfer paint thereonto to contribute to evenly applying a coat of paint to said roller external surface.
